(19) United States
(12) Patent Application Publication
(10) Pub. No.: US 2025/0161135 A1
(43) Pub. Date: May 22, 2025

(54) Adjustable Spinal Traction Apparatus with Progressive Angle Control

(71) Applicant: Nichols Therapy Systems, LLC, Manhattan, KS (US)

(72) Inventor: Jarrod L. Nichols, Manhattan, KS (US)

(73) Assignee: Nichols Therapy Systems, LLC, Manhattan, KS (US)

(21) Appl. No.: 18/890,156

(22) Filed: Sep. 19, 2024

Related U.S. Application Data
(60) Provisional application No. 63/601,536, filed on Nov. 21, 2023.

(51) Int. Cl. A61H 1/02

(52) U.S. Cl. CPC A61H 1/0218; A61H 1/0296; A61H 2201/1607; A61H 2203/0431

(57) ABSTRACT

An apparatus that bends a patient's spine to change the spine's shape includes a traction assembly mounted to a frame. Traction assembly applies a traction force to the spine at an angle to the longitudinal axis of the spine. Traction assembly angularly adjusts about a transverse horizontal axis relative to the frame. A control mechanism progressively adjusts the angle of the applied traction force over a treatment period. Adjustment begins after the applied traction force reaches a minimum percentage of the peak value of the traction force. A fulcrum assembly mounted to the frame applies a fulcrum force to the spine at an angle to the longitudinal axis of the spine. Fulcrum assembly angularly adjusts about the transverse horizontal axis shared by the traction assembly. Control mechanism progressively adjusts the angle of the applied fulcrum force in coordination with the adjustment in the angle of the applied traction force.

### CROSS REFERENCES

This application is a U.S. Non-Provisional application which claims the benefit of U.S. Provisional Application No. 63/601,536, entitled “Adjustable Spinal Traction Apparatus with Progressive Angle Control”, filed on 21 Nov. 2023, which is incorporated herein by reference in its entirety.

### REFERENCE TO RESEARCH

Not Applicable.

### REFERENCE TO CDS

Not Applicable.

### TECHNICAL FIELD

The present disclosure relates to extension traction therapy for correcting abnormal spinal curves and, particularly, to an improved chiropractic apparatus and methods for non-surgical correction of the shape of the cervical region of a person's spine.

### BACKGROUND

Spinal conditions and disorders can be treated by manipulating the shape of a person's spine. Traction forces may be applied to the spine to induce extension, bending, and realignment. Chiropractic medicine has focused largely on the concept that manipulation of the spine allows improved functional movement, which in turn allows greater overall spinal function and general health. This concept has been shown to offer symptomatic relief to patients and temporarily correct abnormal spinal structure.

Soft tissues associated with the spine and other body structures exhibit a unique characteristic known as “viscoelasticity.” This property allows soft tissues to return to their original shape and length if a submaximal force is applied for a relatively short period of time. This scenario may explain why traditional spinal manipulation typically does not cause a permanent change in the structure of the spine.

Soft tissues also exhibit the property of “plastic deformation’, by which the tissues deform permanently if a greater force is applied to the soft tissues for a relatively prolonged period of time. Thus, “extension” traction therapy, which applies a force at an angle to the longitudinal axis of the spine for a therapeutic duration of time has been shown to correct abnormal spinal curves.

### SUMMARY

In some aspects, the techniques described relate to an apparatus for bending a spine of a patient to change the shape thereof, the apparatus including: (a) a frame; (b) a traction assembly mounted to the frame, the traction assembly structured to apply a traction force to the spine at an angle to the longitudinal axis of the spine to bend the spine, wherein the traction assembly is structured to angularly adjust about a transverse horizontal axis relative to the frame; and (c) a control mechanism operable to progressively adjust the angle of application of the applied traction force over a predetermined period of time during a treatment period from an initial traction angle after the applied traction force has reached a minimum percentage of a peak value of the traction force.

In some aspects, the techniques described relate to an apparatus, wherein the initial traction angle is between +26° from vertical and −10° from vertical.

In some aspects, the techniques described relate to an apparatus, wherein the angle of application of the applied traction force is progressively adjusted between +26° from vertical and −136° from vertical over the predetermined period of time during the treatment period.

In some aspects, the techniques described relate to an apparatus, wherein the angle of application of the traction force is adjustable from the initial traction angle by between +26° from vertical and −10° from vertical over the predetermined period of time during the treatment period.

In some aspects, the techniques described relate to an apparatus, further including: (d) a fulcrum assembly mounted to the frame, the fulcrum assembly structured to apply a fulcrum force to the spine at an angle to the longitudinal axis of the spine to bend the spine, wherein the fulcrum assembly is structured to angularly adjust about the transverse horizontal axis shared by the traction assembly.

In some aspects, the techniques described relate to an apparatus, wherein the control mechanism is further operable to progressively adjust the angle of application of the applied fulcrum force over the predetermined period of time during the treatment period from an initial fulcrum angle.

In some aspects, the techniques described relate to an apparatus, wherein the angle of application of the applied fulcrum force is adjusted after the applied traction force has reached a minimum percentage of peak value of the traction force.

In some aspects, the techniques described relate to an apparatus, wherein the control mechanism begins adjusting the angle of application of the applied fulcrum force from an initial fulcrum angle in coordination with adjustment of the angle of application of the applied traction force.

In some aspects, the techniques described relate to an apparatus, wherein the initial fulcrum angle is between −20° from horizontal and +20° from horizontal.

In some aspects, the techniques described relate to an apparatus, wherein the angle of application of the applied fulcrum force is progressively adjusted between −20° from horizontal and +20° from horizontal over the predetermined period of time during the treatment period.

In some aspects, the techniques described relate to an apparatus, wherein the angle of application of the fulcrum force is adjustable from the initial fulcrum angle by between −20° from horizontal and +20° from horizontal.

In some aspects, the techniques described relate to an apparatus, wherein the minimum percentage of the peak value of the traction force is between 10% and 80%.

In some aspects, the techniques described relate to a method for bending a spine of a patient to change the shape thereof, the method including the steps of: (a) applying an applied traction force to the spine with a traction assembly mounted to a frame at an initial traction angle to the longitudinal axis of the spine; (b) increasing, progressively, the applied traction force up to a peak value of the traction force; and (c) adjusting, with a control mechanism, the angle of application of the traction force by the traction assembly about a transverse horizontal axis relative to the frame from an initial traction angle over a predetermined period of time during the treatment period after the applied traction force has reached a minimum percentage of the peak value of the traction force.

In some aspects, the techniques described relate to a method, wherein the angle of application of the applied traction force is adjusted progressively, with the control mechanism, over the predetermined period of time during the treatment period from the initial traction angle to a final traction angle to the longitudinal axis of the spine.

In some aspects, the techniques described relate to a method, further including the steps of: (d) applying an applied fulcrum force to the spine with a fulcrum assembly mounted to the frame at an initial fulcrum angle to the longitudinal axis of the spine; and (e) adjusting the angle of application of the fulcrum force from the initial fulcrum angle over the predetermined period of time during the treatment period.

In some aspects, the techniques described relate to a method, wherein adjustment of the angle of application of the applied fulcrum force is made in response to adjustment of the angle of application of the applied traction force.

In some aspects, the techniques described relate to a method, further including the step of: (f) adjusting, with a control mechanism, the angle of the fulcrum assembly about the transverse horizontal axis shared by the traction assembly from the initial fulcrum angle over the predetermined period of time during the treatment period.

In some aspects, the techniques described relate to a method, wherein the step of adjusting the angle of application of the fulcrum force is completed by the control mechanism after the traction force has reached the minimum percentage of the peak value of the traction force.

In some aspects, the techniques described relate to a method, further including the step of: (g) adjusting, progressively, the angle of application of the fulcrum force, with the control mechanism, over the predetermined period of time during the treatment period from the initial fulcrum angle to a final fulcrum angle to the longitudinal axis of the spine.

In some aspects, the techniques described relate to a method, further including the steps of: (h) commanding, with the control mechanism, the adjustment in the angle of application of the applied fulcrum force in coordination with the adjustment in the angle of application of the applied traction force.

In some aspects, the techniques described relate to a method, further including the steps of: (i) adjusting, progressively, the angle of application of the applied traction force with the control mechanism over the predetermined time during the treatment period from the initial traction angle to a final traction angle to the longitudinal axis of the spine; and (j) commanding, with the control mechanism, a progressive adjustment in the angle of application of an applied fulcrum force by a fulcrum assembly from an initial fulcrum angle to a final fulcrum angle to the longitudinal axis of the spine in coordination with the adjustment in the angle of application of the applied traction force by the traction assembly.

In some aspects, the techniques described relate to a method, wherein the minimum percentage of the peak value of the traction force is between 10% and 80%.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

### BRIEF DESCRIPTION OF DRAWINGS

Aspects are illustrated by way of example, and not by way of limitation, in the accompanying drawings, wherein:

FIG. 1 depicts a left front perspective view of an example of an apparatus for bending the spine of a patient.

FIG. 2 depicts a right rear perspective view of the apparatus of FIG. 1.

FIG. 3 depicts a left rear perspective view of the apparatus from above the apparatus.

FIG. 4 depicts a left side elevation view of treatment being applied to a patient in which an applied fulcrum force and an applied traction force cooperate to provide restorative curvature to the cervical region of the patient's spine.

FIG. 5 depicts a left side elevational view illustrating how the angle of force applications by the fulcrum assembly and traction assembly may be adjusted during treatment.

FIG. 6 depicts a graph illustrating the percentage progression of peak traction force and fulcrum force relative to hypothetical adjustments made to the applied traction angle and applied fulcrum angle by the traction assembly and fulcrum assembly, respectively, over an individual treatment period.

FIG. 7 depicts a flowchart of an example treatment method for correcting abnormal spinal curves.

### DETAILED DESCRIPTION

An adjustable spinal traction apparatus described herein bends the spine of a patient to change the shape of the spine with improved control and accuracy. The apparatus bends the spine by adjusting an angle of application of a traction force with a traction assembly. The angle of the traction force applied adjusts over a predetermined period during treatment. The traction assembly adjusts the angle of application from an initial traction angle to a final traction angle. The traction assembly is structured to adjust the angle of application of the traction force between +26° and −136° from vertical.

Existing apparatus systems for bending the spine have limitations in terms of adjustability and control over the applied traction force. These systems lack the ability to adjust the angle of application of the traction force after the traction force has reached a minimum percentage of a peak value of the traction force. The functional method by which the disclosed apparatus operates considers that muscles may tighten around a treatment area as the body tries to protect itself from discomfort or pain from an injury known as “muscle guarding”. Muscle guarding by the patient may prevent administering adequate traction force to the soft tissues of the spine during treatment for correction of abnormal spinal structure. As a result, the bending of the spine may not be optimized for each patient's specific condition, leading to suboptimal treatment outcomes.

During treatment, the apparatus progressively increases the traction force to a minimum percentage of the peak value of the traction force. The apparatus begins adjusting the angle of application of the traction force after the traction force has reached the minimum percentage of the peak value of the traction force. The angle of application of the traction force may be continuously and variably adjusted upon reaching the minimum percentage of the peak value of the traction force. Administering a traction force at a minimum percentage before making adjustment to the angle of application of the traction force may overcome the patient's tendency to muscle guard against the treatment being applied.

Additionally, the disclosed apparatus is structured to bend the spine of a patient by progressively adjusting an angle of application of a fulcrum force. The apparatus bends the spine by adjusting the angle of application of the fulcrum force applied over the predetermined period of treatment. A fulcrum assembly of the apparatus progressively adjusts the angle of application of the fulcrum force from an initial fulcrum angle to a final fulcrum angle. The fulcrum assembly is structured to adjust the angle of application of the fulcrum force between −20° and +20° from horizontal. The angle of application of the fulcrum force adjusts in response to an adjustment of the angle of application of the traction force.

Control mechanism 236 may command the fulcrum assembly to coordinate adjustment in the angle of application of the fulcrum force with the adjustment in the angle of application of the traction force by the traction assembly. During angular adjustments, the point of contact between the fulcrum member 12 and the patient's cervical region may be maintained as adjustment in the angle of application in the traction angle, fulcrum angle, or a combination of the two occurs during treatment. The control mechanism 236 may coordinate the adjustment in the angle of application of the fulcrum angle from an initial fulcrum angle, starting at a neutral fulcrum position, to a final fulcrum angle, relative to the adjustment in the angle of application of the traction angle from an initial traction angle, starting at a neutral traction position, to a final traction angle as the treatment progresses to completion.

During treatment, the apparatus begins adjusting the angle of application of the fulcrum force after the traction force has reached the minimum percentage of the peak value of the traction force. The angle of application of the fulcrum force may be continuously and variably adjusted upon the traction force reaching the minimum percentage of the peak value of the traction force. Administering a traction force at a minimum percentage before making adjustment to the angle of application of the fulcrum force may overcome the patient's tendency to muscle guard against the treatment being applied.

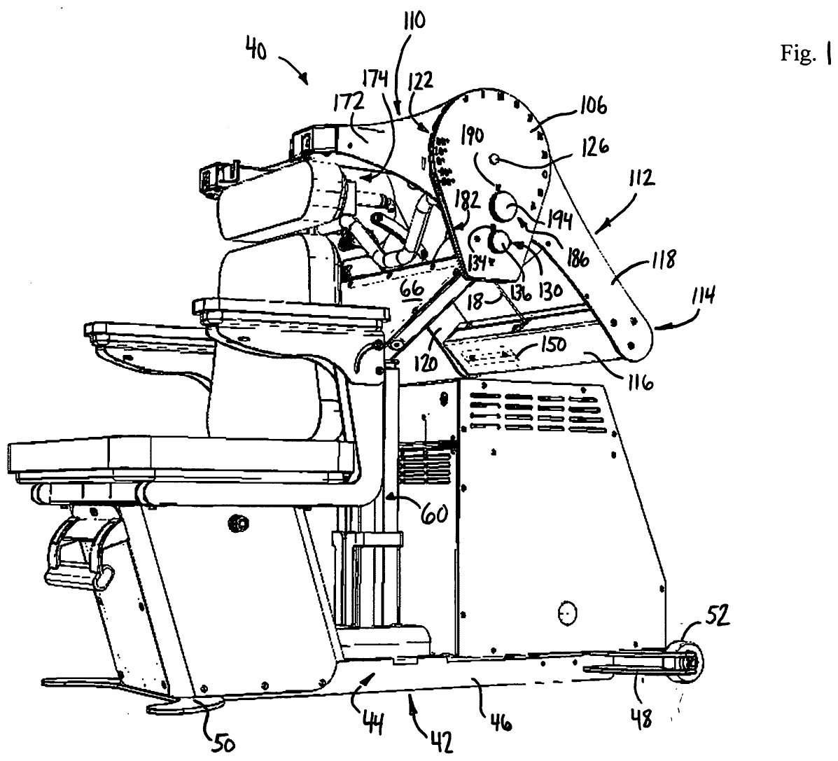

FIG. 1 depicts an apparatus 40 that includes a frame 42. Frame 42, being broadly identified, may support all portions of apparatus 40. Frame 42 includes a generally I-shaped base having a longitudinal member 46 that extends fore-and-aft between a pair of cross members 48, 50 that extend transversely at opposite ends of the longitudinal member 46. Wheels 52, 54 at opposite ends of rear cross member 48 make the apparatus 40 operable to be tipped up and rolled between different locations. Wheels 52, 54 may be spaced slightly above the floor or in light engagement with the floor. Base 44 and cross members 48, 50 may provide the primary load-bearing engagement of the apparatus 40 with the floor. A pair of non-skid pads may be positioned at opposite ends of cross member 50 at the front of the apparatus 40. The non-skid pads engage the floor to help retain the position of the apparatus 40 in a selected location during treatment.

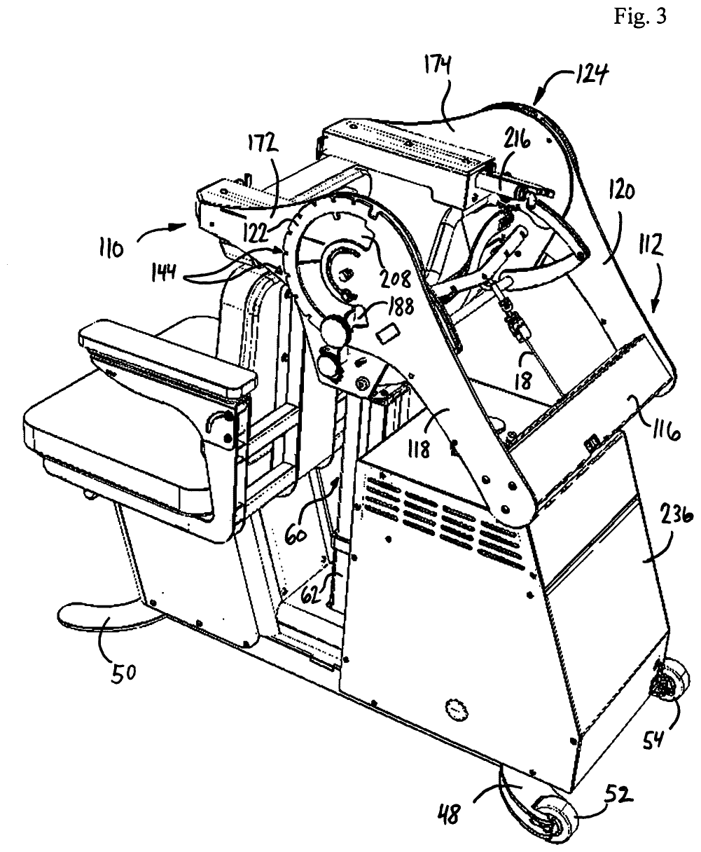

A traction assembly 112 may mount to frame 42. Traction assembly 112 is structured to apply a traction force to the spine. The traction force is applied at an angle to the longitudinal axis of the spine to bend the spine. Traction assembly 112 is structured to angularly adjust about a transverse horizontal axis relative to frame 42. Traction assembly 112 includes a yoke 114 that is U-shaped and extends generally rearward behind the patient when seated. Yoke 114 includes a pair of traction legs 118, 120 that mount at opposite lateral ends of a bight 116. Bight 116 is rearwardly disposed and extends forwardly from traction legs 118, 120 at their rearward most, distal ends. Now referring to FIG. 3, at their forward most, proximal ends, traction legs 118, 120 may be rigidly fixed to respective crescents 122, 124 that are mounted upon respective pivots 126, 128 to end plates 106, 108 near the upper ends thereof. Yoke 114 swings about pivots 126, 128 to adjust up and down about the transverse horizontal axis. The transverse horizontal axis is defined by the pivots 126, 128 that are horizontally aligned.

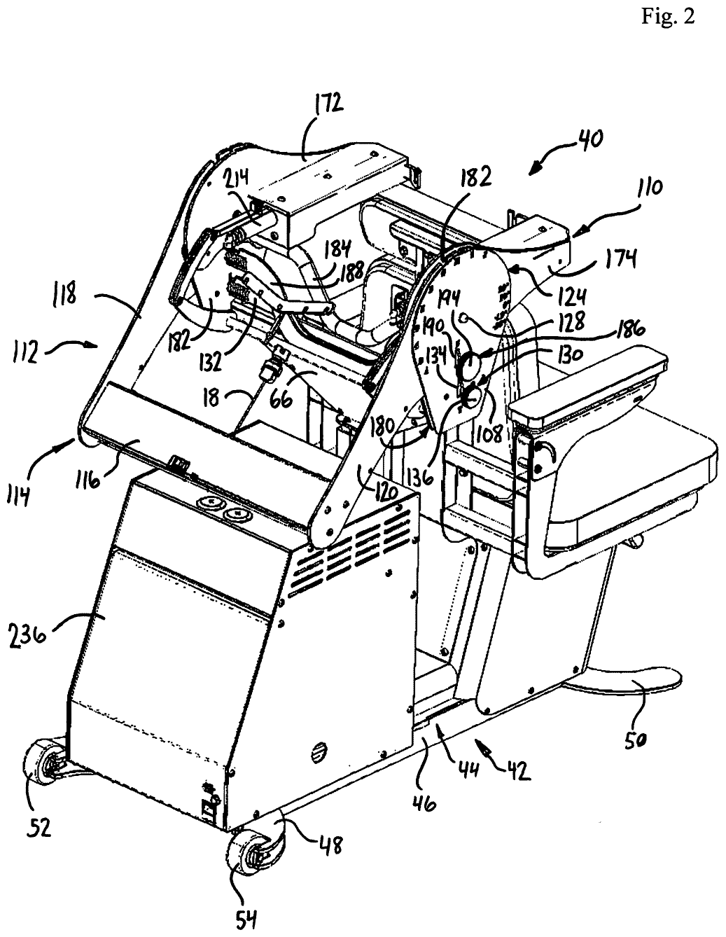

Now referring to FIG. 2, a latch 130 that is releasable may be provided for optionally locking traction assembly 112 in an angular adjustment position about pivots 126, 128. Latch 130 may take a variety of different forms to provide an infinite number of positions for locking the traction assembly 112 at a selected position. In FIG. 2, latch 130 is shown with a lock bar 132 that spans the pair of end plates 106, 108 and passes through corresponding slots 134 therein to project outwardly beyond respective end plates 106,108 when latched.

Lock bar 132 may be optionally retained in a position for latching engagement with crescents 122, 124. Knobs 136 attached to opposite ends of lock bar 132 facilitate manual gripping and operation thereof. Alternatively, the facilitation of lock bar 132 being shifted longitudinally between latched and unlatched positions may be commanded by control mechanism 236. Because lock bar 132 is shiftable lengthwise between end plates 106, 108, tabs of the lock bar 132 may be positioned for locking engagement within any one of a series of downwardly projecting notches 144 in the corresponding crescents 122 and 124. For convenience, the series of notches 144 along the arcuate lower extremity of each crescent 122 or 124 may be labeled with numerals, alphabet letters, or other indicia to provide a visually observable indication of the selected angular position for yoke 114.

A latch 186 that is releasable is provided for optionally locking fulcrum assembly 110 in an angular adjustment position about pivots 126, 128. Like latch 130 for the traction assembly 112, latch 186 for the fulcrum assembly 110 may take a variety of different forms to provide an infinite number of positions for locking the fulcrum assembly 110 at a selected position. As illustrated, latch 186 is a similar design to latch 130 and includes a lock bar 188 that transversely spans the two end plates 106, 108 and passes through slots 190 therein to project a short distance beyond end plates 106, 108 when latched.

Lock bar 188 may also pass through a clearance opening in each mounting plate 180, 182. It will be noted that each of the crescents 122, 124 has an arcuate cutout 208. Arcuate cutout 208 allows lock bar 188 to project outwardly through crescents 122, 124 at its opposite ends without interference. Alternatively, lock bar 188 may be optionally retained in a position for latching engagement with crescents 122, 124. Knobs 194 on opposite ends of lock bar 188 facilitate longitudinal shifting thereof between latched and unlatched positions.

Yoke 114 may support a power device 150 that is operably coupled with an axial tensioner 18 for exerting the traction force during the treatment period. Power device 150 may be operated by a pneumatic, hydraulic, or electrical input. In one example, power device 150 may be fluid-pressure operated when coupled with a source of gas or fluid pressure and a control mechanism 236. In a preferred example, power device 150 may be electrically operated when coupled with a source of electric power and a control mechanism 236.

Power device 150 may be a direct current electric motor. An advantage to the use of a direct current electric motor is that forces applied by the traction assembly and the fulcrum assembly may be cushioned. In one example, negative feedback from the electric motor in response to a change in the applied force may be sent to the control mechanism 236. In response, control mechanism 236 may adjust the amount of electric current to the electric motor to apply an adjusted amount of force. An advantage is that the electric motor adjusts to apply the right amount of treatment force even if the patient does not remain stationary when seated upon the apparatus. Adjustments to the treatment position by the patient that are unaccounted for are still factored by cushioning the forces applied.

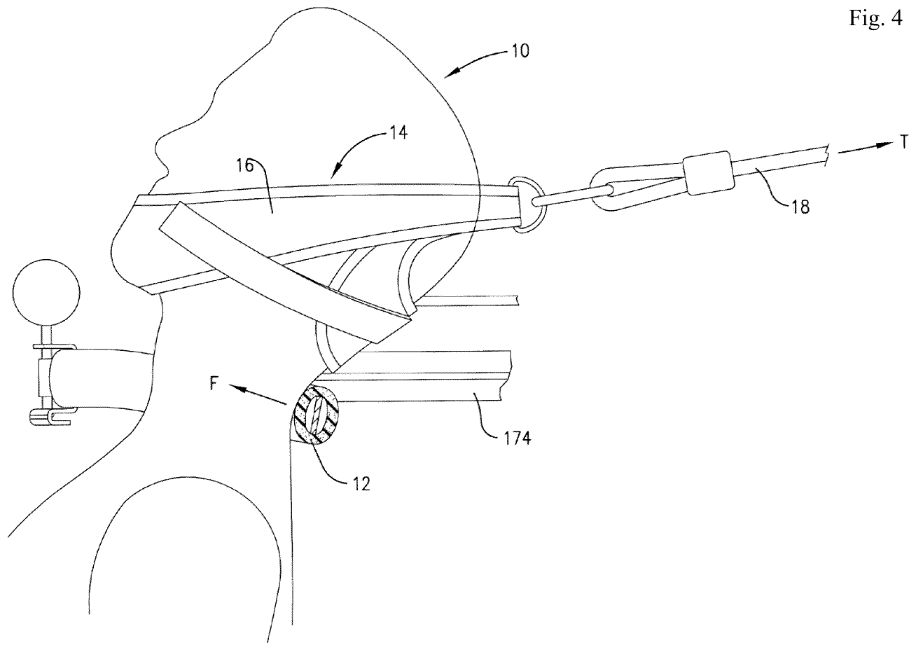

The axial tensioner 18 may be a pulling device such as a rope, cord, chain, acme screw, all thread rod, tensioning rod, wire, or bar having a length to span a distance between the bight 116 and a headgear 14. An example of the headgear 14 that may mount with the head of a patient seated upon the apparatus 40 is shown in FIG. 4.

The axial tensioner 18 may be operably coupled with the power device 150. The connection between the two may take a variety of different forms. The length of the axial tensioner 18 may be adjusted to accommodate different patients and different angles of adjustment by the traction assembly 112. The traction force exerted by axial tensioner 18 increases during the treatment of a patient as the length of the axial tensioner 18 decreases. The traction force exerted by axial tensioner 18 decreases during the treatment of a patient as the length of the axial tensioner 18 increases.

Existing apparatus systems for angularly adjusting the spine have limitations in terms of adjustability and control over the angle of application of the applied traction force. These systems lack a control mechanism that can progressively adjust the angle of application of the applied traction force over a predetermined interval of time during the treatment period. Furthermore, some systems lack the ability to determine when the applied traction force has reached a minimum percentage of a peak value of the traction force. Apparatus 40 includes a control mechanism 236 operable to progressively adjust the angle of application of the applied traction force over a predetermined interval of time during a treatment period. The control mechanism 236 may be part of an overall control system for apparatus 40. The control mechanism 236 may be supported or unsupported by frame 42.

Control mechanism 236 controls adjustment of both the traction force and a fulcrum force during a treatment period. The control mechanism 236 may be operably connected with the power device 150, or a plurality of power devices, to coordinate adjustment of the fulcrum assembly and traction assembly simultaneously together, or independently adjust the assemblies, one from the other. Power device 150 may be networked to the control system. The control system may include a programmable logic controller or a computer. The control mechanism 236 may be programmed to provide electrical control signals to the power device 150. The control mechanism 236 may regulate the amount of electrical power to the power device 150. The control mechanism 236 may control several apparatuses simultaneously, or a single apparatus as illustrated in the Figures.

The duration of a treatment period for the type of cervical spine therapy described herein may range between approximately 5 minutes to 20 minutes. The prescribing physician determines the duration of the treatment period based on the presentation of symptoms by a patient and the patient's tolerance of the spinal therapy. The prescribing physician prescribes a treatment plan based on these factors. At the initiation of the treatment plan, the patient may be treated for a period of around 5 minutes during initial treatment sessions. The treatment period may progressively increase during subsequent treatment sessions to around 15 minutes to 20 minutes as the patient develops tolerance to the spinal therapy.

At least one of the forces, the fulcrum force or traction force, and preferably both, are progressively increased over the predetermined period of time during the treatment period. The increase may be “stair stepped”. Alternatively, in a preferred mode, the increase is progressively continuous. Smooth, gradual increase of forces over a treatment period, such as more than five minutes, for example, may have the cumulative effect of stretching or plastically deforming the soft tissues associated with the cervical region. The deformation may be to such an extent that the soft tissues are permanently reshaped after the forces are removed.

Apparatus 40 may be operable to progressively increase the fulcrum force independently, or in combination with the traction force being increased. Either the traction force or the fulcrum force may increase while the other remains constant. In one preferred manner of operation during the treatment period, the traction force increases progressively, dependent on the peak value of the traction force, until a minimum percentage of the peak value is reached. The control mechanism 236 then adjusts the traction assembly 112 from an initial traction angle after the applied traction force has reached the minimum percentage of the peak value of the traction force to avoid discomfort in the patient and associated muscle guarding. During adjustment of the angle of application of the traction force, both the fulcrum force and traction force may progressively increase at a similar, continuous rate of progress, although perhaps in different amounts of force depending on their respective peak values, until a final traction angle is obtained.

The treatment parameters, including for example angles of application, ranges of angle adjustment, peak forces, rates of increase, and lengths of treatment time, will vary from patient-to-patient and from treatment-to-treatment. Different patients obviously have different needs and tolerances, which means that the angle, force, and time values selected for different patients are likely to vary. Even with the same patient, it is contemplated that several different treatments will be involved over a period of several days or weeks or months, with each treatment typically being slightly different than the previous treatment. The most beneficial ranges for the treatment parameters may depend on the treatment plan devised by the practicing physician based on the patient being treated.

Table 1, which follows, sets forth hypothetical treatment parameters in one example of a treatment session that might be set by a practicing physician for a patient treatment plan:

TABLE 1

| Traction Assembly | | | Fulcrum Assembly | | |
|---|---|---|---|---|---|
| Peak Traction Force | 15 | lb | Peak Fulcrum Force | 5 | lb |
| Initial Traction Angle | +26 | degrees | Initial Fulcrum Angle | 0 | degrees |
| Final Traction Angle | −118 | degrees | Final Fulcrum Angle | +10 | degrees |
| Begin Adjustment | 50% of Peak | | Begin Adjustment | 50% of Peak | |
| End Adjustment | 95% of Peak | | End Adjustment | 95% of Peak | |
| Treatment Period | 15 | min. | Treatment Period | 15 | min. |

The peak value of the traction force may be between 5 lb and 50 lb. The peak value of the traction force may be further between 5 lb and 45 lb, between 5 lb and 40 lb, between 5 lb and 35 lb, between 5 lb and 30 lb, between 5 lb and 25 lb, between 25 lb and 45 lb, between 20 lb and 45 lb, between 15 lb and 45 lb, between 10 lb and 45 lb, between 7.5 lb and 42.5 lb, between 7.5 lb and 37.5 lb, between 7.5 lb and 32.5 lb, between 7.5 lb and 27.5 lb, between 22.5 lb and 42.5 lb, between 17.5 lb and 42.5 lb, between 12.5 lb and 42.5 lb, between 10 lb and 40 lb, between 15 lb and 35 lb, or between 20 lb and 30 lb. The most therapeutically beneficial peak value of the traction force may vary from patient to patient and may be set in accordance with the minimum percentage of the traction force and patient's tolerance to the spinal therapy.

The minimum percentage of the traction force may be between 10% to 90% of the peak value. The minimum percentage of the traction force may be further between 10% to 80% of the peak value, or between 10% to 70%, between 10% to 60%, between 10% to 50%, between 50% to 90%, between 40% to 90%, between 30% to 90%, between 20% to 90%, between 15% to 85%, between 15% to 75%, between 15% to 65%, between 15% to 55%, between 45% to 85%, between 35% to 85%, between 25% to 85%, between 20% to 80%, between 30% to 70%, or between 40% and 60% of the peak value of the traction force. The most therapeutically beneficial percentage range for the minimum percentage of the peak value of the traction force may vary from patient to patient and may depend on the initial traction angle and patient's tolerance to the spinal therapy.

The initial traction angle of the traction force may be between +26° from vertical and −10° from vertical. The initial traction angle of the traction force may be further between +24° and −10°, between +22° and −10°, between +20° and −10°, between +18° and −10°, between +16° and −10°, between +14° and −10°, between +12° and −10°, between +10° and −10°, between +26° and −8°, between +26° and −6°, between +26° and −4°, between +26° and −2°, between +26° and 0°, between +26° and +2°, between +26° and +4°, between +26° and +6°, between +24° and −8°, between +22° and −6°, between +20° and −4°, between +18° and −2°, between +14° and 0°, or between +12° and 2° from vertical. The most beneficial degree range for the initial traction angle of the traction force may vary from patient to patient and may depend on the patient's tolerance to the spinal therapy.

Over the treatment period, the angle of application of the applied traction force may be progressively adjusted between +26° and −136° from the initial traction angle. The angle of application of the applied traction force may be progressively adjusted further between +26° and −130°, between +26° and −124°, between +26° and −118°, between +26° and −112°, between +26° and −106°, between +26° and −100°, between +26° and −90°, between +26° and −80°, between +26° and −70°, between +26° and −60°, between +26° and −50°, between +26° and −40°, between +26° and −30°, between +26° and −20°, between +24° and −136°, between +22° and −136°, between +20° and −136°, between +18° and −136°, between +16° and −136°, between +14° and −136°, between +12° and −136°, between +10° and −136°, between +8° and −136°, between +4° and −136°, between +2° and −136°, between +0° and −136°, between −2° and −136°, between −4° and −136°, between −6° and −136°, between −8° and −136°, between +24° and −130°, between +22° and −124°, between +20° and −118°, between +18° and −112°, between +16° and −112°, between +14° and −106°, between +12° and −100°, between +10° and −90°, between +8° and −80°, between +6° and −70°, between +4° and −60°, between +2° and −50°, between +0° and −40°, between −2° and −30°, or between −4° and −20° from the initial traction angle. The most beneficial degree range for the traction angle of the applied traction force may depend on the initial traction angle, the desired therapeutic outcome as determined by the prescribing physician, and the patient's tolerance to spinal therapy.

Referring to FIG. 2, a fulcrum assembly 110 may mount to frame 42. The fulcrum assembly 110 is structured to apply a fulcrum force to the spine. The fulcrum force is applied at an angle to the longitudinal axis of the spine to bend the spine. Fulcrum assembly 110 is structured to angularly adjust about the transverse horizontal axis shared by the traction assembly 112. The fulcrum assembly 110 includes a pair of fulcrum arms 172, 174 that extend fore-and-aft. At their rearward most, proximal ends, fulcrum arms 172, 174 are movably mounted upon respective mounting plates 180, 182, on upper ends thereof, at the respective pivots 126, 128. Mounting plates 180, 182 are secured, on lower ends thereof, to a cross beam 66 mounted on a mounting post 60 disposed below.

Mounting post 60 may be mounted to frame 42. Mounting post 60 may further have a lower post section 62 with a rectangular cross section and an upper post section 64 that is telescopically received to nest within lower post section 62. The fulcrum assembly 110 and traction assembly 112 move simultaneously up and down together, as the upper post section 64 moves within the lower post section 62. The lower section 62 is mounted at its lower end to longitudinal base member 46 with connecting plates. Upper section 64 is fixed at its upper end to a cross beam 66.

Cross beam 66 is movable up and down as upper post section 64 telescopes within lower post section 62. Cross beam 66 may be adjustably raised and lowered by a jack assembly that is electrically powered. Alternatively, the jack assembly may be manually operated. The jack assembly 68 may take a variety of different forms. A hand crank rotatably supported on outer portion of mounting post 60 may be operably coupled with the jack assembly. The jack assembly is not shown as the jack assembly is an internal mechanism within mounting post 60. Telescoping movement of upper post section 62 occurs when the jack assembly is electrically or manually operated.

Mounting plates 180, 182 are rigidly mounted and positioned at opposite ends of a cross bar 184. Cross bar 184 is elongated to transversely span the distance between mounting plates 180, 182 and is rigidly affixed therebetween at its opposite ends to help provide structural rigidity to the fulcrum assembly 110. Fulcrum assembly 110 swings about pivots 126, 128 to adjust up and down about the transverse horizontal axis. Cross bar 184 is downwardly bowed at its mid-section to ensure clearance with the patient's head during treatment.

The forward most, distal ends of fulcrum arms 172, 174 of fulcrum assembly 110 terminate forward of cross bar 184 at a frontal position on opposite sides that are adjacent to a patient's head. The fulcrum member 12 has a length to span a distance between the distal ends of fulcrum arms 172, 174. Opposite ends of fulcrum member 12 are secured to the respective distal ends of fulcrum arms 172, 174. Fulcrum arms 172, 174 may rotate about the transverse horizontal axis defined by pivots 126, 128 for positioning of the fulcrum member 12. Rotational movement for angular adjustment of the fulcrum member 12 by the fulcrum assembly 110 may be performed in conjunction with adjustment of traction assembly 112.

Fulcrum assembly 110 may support an independent power device or power devices 214, 216 operably coupled with the fulcrum member 12 for exerting the fulcrum force during the treatment period. Power devices 214, 216 may be a pair of fluid pressure-operated cylinders attached to bracket guides fixed to the mounting plates 180, 182. In one example, the power devices 214, 216 comprise air cylinders operated when coupled with a source of pressurized air and a control mechanism 236. The source of gas or fluid pressure may be the same source utilized by the power device 150 for the traction assembly 112. Other types of power devices may be utilized in lieu of the air cylinders including, without limitation, hydraulic cylinders, electrical motors, and hydraulic, air, and electric actuators. In a preferred example, power devices 214, 216 may be electrically operated when coupled with a source of electric power and a control mechanism 236. Power devices 214, 216 may be a pair of direct current electric motors. The fulcrum member 12 may be a pushing device such as a curved bar, foam-covered strap, or take on a variety of different forms for supporting the cervical region (neck) of the patient's spine as illustrated in FIG. 4.

As shown in FIG. 4, a pair of forces are applied to the cervical region. The fulcrum force F is applied forwardly by a fulcrum member 12 pushing against the posterior portion of the cervical region to improve the biomechanical structure or shape of the spine. The traction force T is applied rearwardly by the axial tensioner 18 pulling against the head of the patient 10 received by the headgear 14. The traction force T provides pull extension on the spine in a generally opposite direction at an angle to the longitudinal axis of the spine to bend the cervical region rearwardly about the fulcrum member 12 to stretch the spinal soft tissues. Traction force T being applied through the headgear 14 includes a chin strap 16. The headgear 14 is pulled upwardly and rearwardly by the axial tensioner 18. The headgear 14 illustrated in FIG. 4 may be any number of different means by which axial tensioner 18 could be operably coupled with the head of a patient 10. Likewise, while the fulcrum member 12 is illustrated as comprising a foam-covered strap, the fulcrum member 12 may take a variety of different forms as well.

The angle of application of the fulcrum force may be adjusted by the fulcrum assembly 110 over the predetermined period during the treatment period from the initial fulcrum angle. The initial fulcrum angle of the fulcrum force may be between −20° from horizontal and +20° from horizontal. The initial fulcrum angle of the fulcrum force may be further between +18° and −20°, between +16° and −20°, between +14° and −20°, between +12° and −20°, between +10° and −20°, between +20° and −18°, between +20° and −16°, between +20° and −14°, between +20° and −12°, between +20° and −10°, between +18° and −18°, between +16° and −16°, between +14° and −14°, between +12° and −12°, between +10° and −10°, between +20° and −8°, between +18° and −6°, between +16° and −4°, between +14° and −2°, between +12° and 0°, between 0° and −12°, between +10° and −10°, between +8° and −8°, between +6° and −6°, or between +4° and −4° from horizontal. The most beneficial degree range for the initial fulcrum angle of the fulcrum force may depend on the desired therapeutic outcome as determined by the prescribing physician and the patient's tolerance to spinal therapy.

Over the treatment period, the angle of application of the applied fulcrum force may be progressively adjusted between −20° and +20° from the initial fulcrum angle. The angle of application of the applied fulcrum force may be progressively adjusted further between +18° and −20°, between +16° and −20°, between +14° and −20°, between +12° and −20°, between +10° and −20°, between +20° and −18°, between +20° and −16°, between +20° and −14°, between +20° and −12°, between +20° and −10°, between +18° and −18°, between +16° and −16°, between +14° and −14°, between +12° and −12°, between +10° and −10°, between +20° and −8°, between +18° and −6°, between +16° and −4°, between +14° and −2°, between +12° and 0°, between 0° and −12°, between +10° and −10°, between +8° and −8°, between +6° and −6°, or between +4° and −4° from the initial fulcrum angle. The most beneficial degree range for the angle of application of the applied fulcrum force may depend on the initial fulcrum angle, the desired therapeutic outcome as determined by the prescribing physician, and the patient's tolerance to the spinal therapy.

Adjustment to the angle of application of the applied fulcrum force may be directed by the control mechanism which is operable to both progressively adjust the traction assembly 112 and the fulcrum assembly 110 simultaneously together, or independently, during treatment. Previously, the position of the fulcrum assembly 110 and the traction assembly 112 were set to fixed positions after which the apparatus 40 was activated and traction force applied at the set traction angle for extension of the patient's spine about the stationary fulcrum member. Now, adjustment of the angle of application of the applied fulcrum force may coordinate with adjustment of the angle of application of the applied traction force during treatment. The angle of application of the applied fulcrum force may be adjusted after the applied traction force has reached a minimum percentage of peak value of the traction force.

The control mechanism may begin adjusting the angle of application of the applied fulcrum force, from the initial fulcrum angle, after the minimum percentage of the peak value of the traction force is reached. The angle of application of the applied fulcrum force may be adjusted when the minimum percentage of the traction force is between 10% to 90% of the peak value of the traction force. The minimum percentage of the traction force may be further between 10% to 80%, or between 10% to 70%, between 10% to 60%, between 10% to 50%, between 50% to 90%, between 40% to 90%, between 30% to 90%, between 20% to 90%, between 15% to 85%, between 15% to 75%, between 15% to 65%, between 15% to 55%, between 45% to 85%, between 35% to 85%, between 25% to 85%, between 20% to 80%, between 30% to 70%, or between 40% and 60% of the peak value of the traction force before the angle of application of the applied fulcrum force begins to adjust. The most therapeutically beneficial percentage range for the minimum percentage of the peak value of the traction force may depend on the initial fulcrum angle, the initial traction angle, the desired therapeutic outcome as determined by the prescribing physician, and the patient's tolerance to the spinal therapy.

A new treatment method for apparatus 40 may now allow for angle adjustability of the fulcrum assembly 110 and traction assembly 112 during treatment applications. Previously, angles of adjustment in the fulcrum assembly and traction assembly were adjusted manually with a lever and set to desired treatment angles prior to the start of application of the traction force and fulcrum force on the spine, in which the angles remained static throughout the spinal treatment. In the treatment method disclosed, treatment parameters, such as the traction angle and the fulcrum angle, are input into the control system prior to starting treatment. Electric motors operably connected to the control mechanism will activate the fulcrum assembly 110 and the traction assembly 112 to progressively move through applied traction angles and applied fulcrum angles that are automatically set before application of spinal treatment starts.

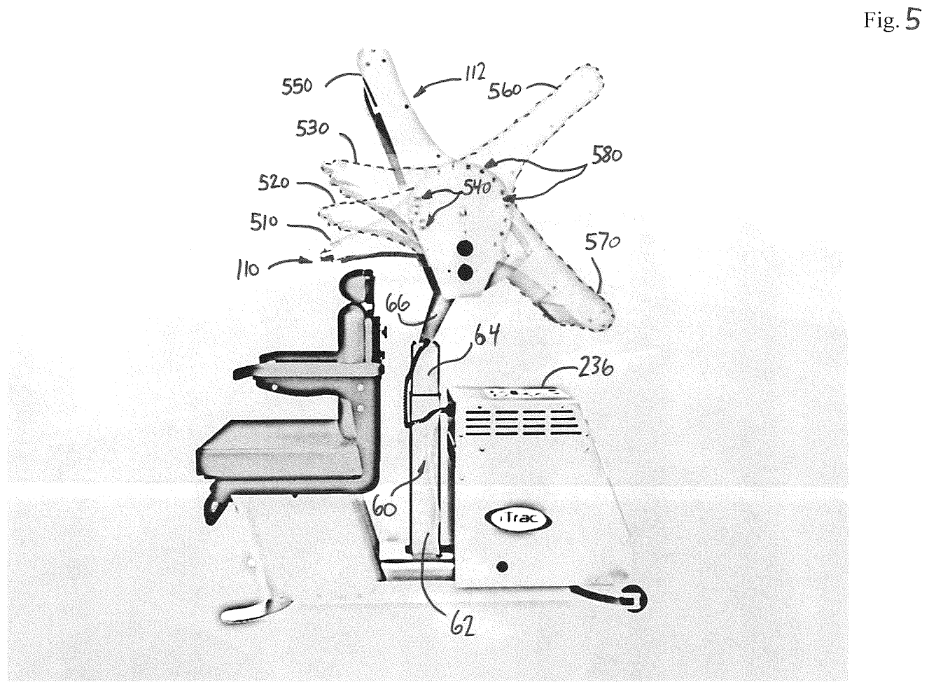

FIG. 5 depicts several relative treatment application positions for the fulcrum assembly 110 and the traction assembly 112, in phantom (dashed lines), to illustrate the way in which apparatus 40 adjusts angles of application of the applied fulcrum force and applied traction force during treatment from a neutral starting position. Patients may be in a seated position upon apparatus 40 that is structured for such treatment orientations as illustrated in FIG. 5. However, the treatment method is not limited to having the patient seated. In some instances, it may be preferable to structure the apparatus 40 to have the patient lying down, reclined, or standing for application of the treatment method.

A common challenge practicing physicians face while applying extension traction to a patient is the discomfort that some patients experience while being set up in certain extension positions before traction is applied. Particularly, practicing physicians may find patients muscle guarding against being set up in extension positions that are at, or near, final treatment positions due to the compression of irritated spinal tissues, spinal facet joints, and intervertebral discs. This discomfort may remain until an axial traction force is applied to the spine of the patient so that decompression of these joint tissues provides relief so that extension of the spine into final treatment positions can occur.

The treatment method for spinal extension described herein allows for the spine of a patient, the fulcrum assembly 110, and the traction assembly 112 to start in a neutral starting position, during treatment setup, before application of traction and extension occurs. When treatment begins, the traction force is applied first, decompressing the spinal joints, followed by the fulcrum assembly 110 applying the fulcrum force. The traction force may be applied up to a minimum percentage of the peak value of the traction force before the fulcrum force is applied. After the applied traction force reaches a minimum percentage of the peak value of the traction force, the fulcrum assembly 110 and traction assembly 112 gradually adjust angles of application of the applied fulcrum force and the applied traction force, respectively, to final angle positions in application of extension to the spine.

Axial distraction of the cervical spine with slight extension to target cervical curve loss with minimal forward head posture may be applied for correction of spinal curvature. For example, the initial angle of the fulcrum assembly 110 may be in a neutral fulcrum position 520 set at 0°. The fulcrum member 12 may be positioned at a lower or middle region of the cervical spine at the initial fulcrum angle. The initial angle of the traction assembly 112 may be in a neutral traction position 550 set at +26°. As apparatus 40 begins application of traction during the treatment period, the traction assembly 112 may undergo an angle adjustment from the neutral traction position 550 towards a final traction position 560 set at −38°. Traction angle adjustment may occur after a minimum percentage of the peak value of the applied traction force has been reached. During the treatment period, the fulcrum assembly 110 may undergo an angle adjustment from the neutral fulcrum position 520 towards a positive fulcrum position 530 set at +20°. Fulcrum angle adjustment may occur after the minimum percentage of the peak value of the applied traction force has been reached. At the final fulcrum angle, the point of contact between the fulcrum member 12 and the treatment point of the patient's cervical region may be maintained. Alternatively, the point of contact between the fulcrum member 12 and the treatment point of the patient's cervical region may be allowed to transition to a position at a middle or upper region of the cervical spine at the final fulcrum angle.

Extension of the cervical spine with slight axial distraction to target cervical curve loss with significant forward head posture may be applied for correction of spinal curvature. For example, the initial angle of the fulcrum assembly 110 may be in a negative fulcrum position 510 set at −20°. The fulcrum member 12 may be positioned at a lower or middle region of the cervical spine at the initial fulcrum angle. The initial angle of the traction assembly 112 may be in a neutral traction position 550 set at +26°. As apparatus 40 begins application of traction during the treatment period, the traction assembly 112 may undergo an angle adjustment from the neutral traction position 550 towards a final traction position 570 set at −118°. Traction angle adjustment may occur after a minimum percentage of the peak value of the applied traction force has been reached. During the treatment period, the fulcrum assembly 110 may undergo an angle adjustment from the negative fulcrum position 510 towards a neutral fulcrum position 520 set at 0°. Fulcrum angle adjustment may occur after the minimum percentage of the peak value of the applied traction force has been reached. At the final fulcrum angle, the point of contact between the fulcrum member 12 and the treatment point of the patient's cervical region may be maintained. Alternatively, the point of contact between the fulcrum member 12 and the treatment point of the patient's cervical region may be allowed to transition to a position at a middle or upper region of the cervical spine at the final fulcrum angle.

Coordinated adjustment between the opposing forces and angles of application by the traction assembly and the fulcrum assembly, as they progress during treatment, may be established within the treatment plan by the practicing physician. Based on the presentation of the patient, disc conditions and spinal curvatures, whether targeting a curve loss or curve reversal in the upper, middle, or lower cervical region, the practicing physician may establish an adjustment ratio to be used during progression of treatment. The adjustment ratio may be a function of the degree of angle change between the angle of application of the applied traction force and the angle of application of the applied fulcrum force over the treatment period. For example, the adjustment ratio of the degree of angle change between the applied traction angle and the applied fulcrum angle over the treatment period may be between 1:1 to 10:1, or further between 2:1 to 8:1, or 3:1 to 6:1. The adjustment ratio may be 2:1, 3:1, or 4:1 between the applied traction angle and the applied fulcrum angle as adjustment progresses over the treatment period.

When treatment is complete, the fulcrum assembly 110 and traction assembly 112 progressively return to their respective neutral starting positions and the fulcrum force and traction force would return to a zero amount of force applied in reverse order (i.e., fulcrum force returns to zero, followed by the traction force returning to zero). An advantage to apparatus 40 placing the patient's spine in an extension traction position and returning the patient's spine back to an adjusted neutral position, automatically, is that technical errors performed by a practicing physician during manual manipulation of the spine are avoided.

Markings, such as numerical or letter indicia, may be spaced apart along an arcuate portion of the end plates 106, 108. The markings may be a plurality of fulcrum position indicators 540 and a plurality of traction position indicators 580. Each of the end plates 106, 108 may be provided with the plurality of indicators to visually aid a practicing physician during application of treatment to a patient. The practicing physician may visually analyze the plurality of indicators to ensure the proper angles of treatment application by the fulcrum assembly 110 and the traction assembly 112 are occurring during the treatment period. Positioning and separation between each of the indicators may be based on a range of treatment parameters devised by the practicing physician.

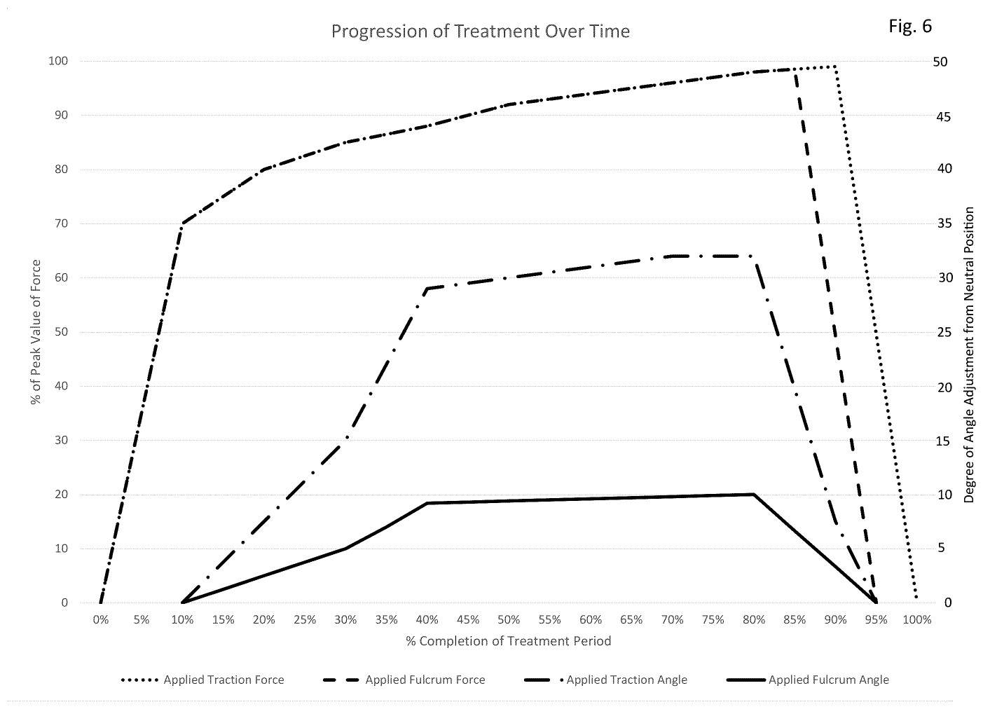

FIG. 6 illustrates a graph of the percentage of peak traction force achieved against the degree of angle adjustment in the applied traction force and the applied fulcrum force over a treatment period. After starting at zero percent at the beginning of the treatment period, the applied traction force continuously increases to a minimum percentage of the peak value of the total traction force. The applied traction force may increase quickly at first to the minimum percentage of the peak value and then slow down but continue to increase until the maximum percentage of the peak value of the total traction force is reached. Alternatively, the applied traction force may increase slowly at first to the minimum percentage of the peak value and then speed up until the maximum percentage of the peak value of the total traction force is reached. Upon the applied traction force reaching the minimum percentage, the applied traction angle of the applied traction force begins to adjust from an initial traction angle to a final traction angle. The applied traction angle of the applied traction force and the applied fulcrum angle of the applied fulcrum force may increase, plateau, or decrease, or any combination thereof, over the remaining portion of the treatment period until the maximum percentage of the peak value of the traction force is reached. Upon reaching their respective peak values, the applied fulcrum force may decrease slowly, or quickly, in a progressive manner back to zero percent while the applied traction force returns to the minimum percentage of the peak value of the total traction force and the angle of the applied traction force returns to the initial traction angle. Upon reaching these parameters, the applied traction force may quickly but progressively drop to zero percent, at which point the treatment period is completed.

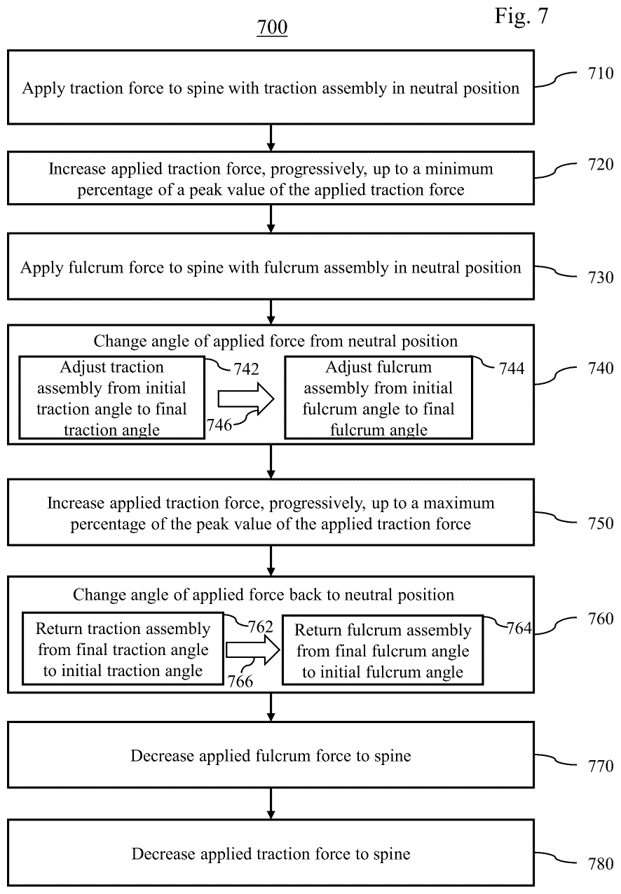

FIG. 7 depicts a flowchart of an example treatment method 700 for bending a spine of a patient to change the shape of the spine. A traction force is applied to the spine, axially, with a traction assembly in a neutral starting position at step 710. The traction assembly mounted to a frame of the apparatus may be positioned at an initial traction angle to the longitudinal axis of the spine. The applied traction force is increased, progressively, up to a minimum percentage of the peak value of the applied traction force at step 720. A fulcrum force is applied to the spine, transversely, with a fulcrum assembly in a neutral starting position at step 730. The angle at which treatment forces are applied to the spine are changed from the neutral starting position at step 740. A control mechanism may adjust the angle at which the traction assembly applies the traction force from an initial traction angle to a final traction angle at substep 742. The control mechanism may adjust the angle at which the fulcrum assembly applies the fulcrum force from an initial fulcrum angle to a final fulcrum angle at substep 744. Adjustment in the angle of application of the applied fulcrum force from the neutral starting position may be made in response to the adjustment of the angle of application of the applied traction force at step 746. The applied traction force is progressively increased up to a maximum percentage of the peak value of the applied traction force at step 750. The angle at which treatment forces are applied to the spine are changed back to the neutral starting position at step 760. The control mechanism may adjust the angle at which the traction assembly applies the traction force from the final traction angle back to the initial traction angle at substep 762. The control mechanism may adjust the angle at which the fulcrum assembly applies the fulcrum force from the final fulcrum angle back to the initial fulcrum angle at substep 764. Adjustment in the angle of application of the applied fulcrum force may be made in response to adjustment of the angle of application of the applied traction force back to the neutral starting position at step 766. After a maximum percentage of the peak value of the fulcrum force has been reached, the fulcrum force applied to the spine by the fulcrum assembly may be decreased back to zero at step 770. The traction force applied to the spine by the traction assembly may be decreased back to zero at step 780.

It is understood that the invention is not confined to the particular construction and arrangement of parts herein described. That although the drawings and specification set forth a preferred embodiment, and although specific terms are employed, they are used in a description sense only and embody all such forms as come within the scope of the following claims.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, are possible from the foregoing descriptions. Such modifications and variations are intended to fall within the scope of the appended claims.

For the convenience of the reader, the above description has focused on a representative sample of all possible embodiments, a sample that teaches the principles of the invention and conveys the best mode contemplated for carrying it out. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed variations, modifications and variations are within the literal scope of the following claims, and others are equivalent.

I claim:

1. An apparatus for bending a spine of a patient to change the shape thereof, the apparatus comprising:
a. a frame;
b. a traction assembly mounted to the frame and structured to apply a traction force to the spine at an angle to the longitudinal axis of the spine to bend the spine, wherein the traction assembly is structured to angularly adjust about a transverse horizontal axis relative to the frame; and
c. a control mechanism operable to progressively adjust the angle of application of the applied traction force over a predetermined period of time during a treatment period from an initial traction angle after the applied traction force has reached a minimum percentage of a peak value of the applied traction force.

2. The apparatus of claim 1, wherein the initial traction angle is between +26° from vertical and −10° from vertical.

3. The apparatus of claim 1, wherein the angle of application of the applied traction force is progressively adjusted between +26° from vertical and −136° from vertical over the predetermined period of time during the treatment period.

4. The apparatus of claim 3, wherein the angle of application of the traction force is adjustable from the initial traction angle by between +26° from vertical and −136° from vertical over the predetermined period of time during the treatment period.

5. The apparatus of claim 1, further comprising:
a. a fulcrum assembly mounted to the frame and structured to apply a fulcrum force to the spine at an angle to the longitudinal axis of the spine to bend the spine, wherein the fulcrum assembly is structured to angularly adjust about the transverse horizontal axis shared by the traction assembly.

6. The apparatus of claim 5, wherein the control mechanism is further operable to progressively adjust the angle of application of the applied fulcrum force over the predetermined period of time during the treatment period from an initial fulcrum angle.

7. The apparatus of claim 6, wherein the angle of application of the applied fulcrum force is adjusted after the applied traction force has reached a minimum percentage of peak value of the applied traction force.

8. The apparatus of claim 5, wherein the control mechanism begins adjusting the angle of application of the applied fulcrum force from an initial fulcrum angle in coordination with adjustment of the angle of application of the applied traction force.

9. The apparatus of claim 8, wherein the initial fulcrum angle is between −20° from horizontal and +20° from horizontal.

10. The apparatus of claim 8, wherein the angle of application of the applied fulcrum force is progressively adjusted between −20° from horizontal and +20° from horizontal over the predetermined period of time during the treatment period.

11. The apparatus of claim 8, wherein the angle of application of the fulcrum force is adjustable from the initial fulcrum angle by between −20° from horizontal and +20° from horizontal.

12. The apparatus of claim 1, wherein the minimum percentage of the peak value of the traction force is between 10% and 80%.

13. A method for bending a spine of a patient to change the shape thereof, the method comprising the steps of:
a. applying a traction force to the spine with a traction assembly mounted to a frame at an initial traction angle to the longitudinal axis of the spine;
b. increasing, progressively, the applied traction force up to a peak value of the applied traction force; and
c. adjusting, with a control mechanism, the angle of the traction assembly about a transverse horizontal axis relative to the frame from the initial traction angle over a predetermined period of time during a treatment period after the applied traction force has reached a minimum percentage of the peak value of the applied traction force.

14. The method of claim 13, wherein the angle of application of the applied traction force is adjusted progressively, with the control mechanism, over the predetermined period of time during the treatment period from the initial traction angle to a final traction angle to the longitudinal axis of the spine.

15. The method of claim 13, further comprising the steps of:
a. applying a fulcrum force to the spine with a fulcrum assembly mounted to the frame at an initial fulcrum angle to the longitudinal axis of the spine; and
b. adjusting the angle of application of the applied fulcrum force from the initial fulcrum angle over the predetermined period of time during the treatment period.

16. The method of claim 15, wherein adjustment of the angle of application of the applied fulcrum force is made in response to adjustment of the angle of application of the applied traction force.

17. The method of claim 15, further comprising the step of:
a. adjusting, with a control mechanism, the angle of the fulcrum assembly about the transverse horizontal axis shared by the traction assembly from the initial fulcrum angle over the predetermined period of time during the treatment period.

18. The method of claim 15, wherein the step of adjusting the angle of application of the applied fulcrum force is completed by the control mechanism after the applied traction force has reached the minimum percentage of the peak value of the applied traction force.

19. The method of claim 15, further comprising the step of:
a. adjusting, progressively, the angle of application of the applied fulcrum force, with the control mechanism, over the predetermined period of time during the treatment period from the initial fulcrum angle to a final fulcrum angle to the longitudinal axis of the spine.

20. The method of claim 15, further comprising the steps of:
a. commanding, with the control mechanism, the adjustment in the angle of application of the applied fulcrum force in coordination with the adjustment in the angle of application of the applied traction force.

21. The method of claim 13, further comprising the steps of:
a. adjusting, progressively, the angle of application of the applied traction force with the control mechanism over the predetermined time during the treatment period from the initial traction angle to a final traction angle to the longitudinal axis of the spine; and
b. commanding, with the control mechanism, a progressive adjustment in the angle of application of an applied fulcrum force by a fulcrum assembly from an initial fulcrum angle to a final fulcrum angle to the longitudinal axis of the spine in coordination with the adjustment in the angle of application of the applied traction force by the traction assembly.

22. The method of claim 13, wherein the minimum percentage of the peak value of the applied traction force is between 10% and 80%.
